(19) United States
(12) Patent Application Publication
(10) Pub. No.: US 2020/0054976 A1
(43) Pub. Date: Feb. 20, 2020

(54) DEVICES AND METHODS FOR WATER FILTRATION

(71) Applicant: NANOFIBER SOLUTIONS, LLC, Hilliard, OH (US)

(72) Inventors: Jed JOHNSON, London, OH (US); Tyler Matthew GROEHL, Columbus, OH (US); Bridget WALSH, West Chester, OH (US)

(73) Assignee: NANOFIBER SOLUTIONS, LLC, Hilliard, OH (US)

(21) Appl. No.: 16/545,403

(22) Filed: Aug. 20, 2019

Related U.S. Application Data
(60) Provisional application No. 62/719,765, filed on Aug. 20, 2018.

(51) Int. Cl. B01D 39/16; C02F 1/70; D01D 5/00; D01F 1/10

(52) U.S. Cl. CPC B01D 39/1623; C02F 1/70; C02F 2101/12; D01F 1/10; D01D 5/0007

(57) ABSTRACT

The instant disclosure is directed to devices and methods for water filtration. A filter may comprise electrospun polymer fibers comprising an effective amount of an additive. The additive may be configured to react with chlorine. A method of manufacturing such a filter may comprise mixing a homogeneous solution comprising a polymer, a solvent, and an effective amount of an additive. The method may further comprise electrospinning the mixture onto a mandrel to form a scaffold comprising electrospun polymer fibers and the additive, and removing the scaffold from the mandrel to form a filter. A method of filtering a chlorine-containing liquid may comprise exposing the chlorine-containing liquid to such a filter, and exposing the chlorine-containing liquid to the filter may produce a purified liquid. The method may further include collecting the purified liquid. The purified liquid may contain about 85% less chlorine than the chlorine-containing liquid.

### CROSS-REFERENCE TO RELATED APPLICATIONS

This application claims priority to and benefit of U.S. Provisional Application Ser. No. 62/719,765, filed Aug. 20, 2019, entitled “Devices and Methods for Water Filtration,” which is incorporated herein by reference in its entirety.

### BACKGROUND

Chlorine is added to drinking water sources to prevent contamination and water-borne illnesses. Many standards allow for up to 4 ppm of chlorine without posing a risk to consumers. While these concentrations of chlorine are not harmful, consumers can often taste them. Therefore, there exists a need for a device and method for water filtration that is capable of filtering out enough of the chlorine just before consumption to make the taste of chlorine undetectable, while not leaving enough time for water contamination to occur.

### SUMMARY

The instant disclosure is directed to devices and methods for water filtration. In an embodiment, a filter may comprise electrospun polymer fibers comprising an effective amount of an additive. The additive may be configured to react with chlorine. In certain embodiments, the additive may be activated carbon, ascorbic acid, or combinations thereof. In some embodiments, the electrospun polymer fibers may comprise a polymer that is nylon 6,6, polycaprolactone, or combinations thereof.

In an embodiment, a method of manufacturing such a filter may comprise mixing a homogeneous solution comprising a polymer, a solvent, and an effective amount of an additive. The additive may be configured to react with chlorine. The method may further comprise electrospinning the mixture onto a mandrel to form a scaffold comprising electrospun polymer fibers and the additive. The method may still further comprise removing the scaffold from the mandrel to form a filter.

In an embodiment, a method of filtering a chlorine-containing liquid may comprise exposing the chlorine-containing liquid to a filter, the filter comprising electrospun polymer fibers comprising an effective amount of an additive. The additive may be configured to react with chlorine, and exposing the chlorine-containing liquid to the filter may produce a purified liquid. The method may further include collecting the purified liquid. In certain embodiments, the purified liquid may contain about 85% less chlorine than the chlorine-containing liquid. In some embodiments, the filter may be located within a container capable of holding the purified liquid, such as a water bottle.

### BRIEF DESCRIPTION OF THE DRAWINGS

FIG. 1 is a scanning electron microscope (SEM) image of an embodiment of a filter comprising electrospun polymer fibers comprising an effective amount of an additive, in accordance with the present disclosure, wherein the electrospun polymers comprise nylon 6,6, and wherein the additive is activated carbon nanoparticles.

FIG. 2 is an SEM image of an embodiment of a filter comprising electrospun polymer fibers comprising an effective amount of an additive, in accordance with the present disclosure, wherein the electrospun polymers comprise polycaprolactone, and wherein the additive is ascorbic acid.

FIG. 3 is an SEM image of an embodiment of a filter comprising electrospun polymer fibers comprising an effective amount of an additive, in accordance with the present disclosure, wherein the electrospun polymers comprise nylon 6,6, and wherein the additive is ascorbic acid.

### DETAILED DESCRIPTION

This disclosure is not limited to the particular systems, devices and methods described, as these may vary. The terminology used in the description is for the purpose of describing the particular versions or embodiments only, and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “fiber” is a reference to one or more fibers and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term comprising is used as the transition phrase, such embodiments can also be envisioned with replacement of the term “comprising” with the terms “consisting of” or “consisting essentially of.”

While many of the embodiments herein are directed to the removal and/or neutralization of chlorine from a liquid, it may be understood that the inclusion of chlorine in the embodiments described herein is non-limiting. In some embodiments, for example, the additive(s) described herein may be configured to react with chlorine. In other embodiments, though, it may be understood that the additive(s) described herein may be configured to react with one or more other undesirable components that may be present in a liquid. The other undesirable component(s) may include, for example, one or more heavy metals, one or more pesticides, one or more fertilizers, one or more herbicides, one or more pharmaceutical compounds, one or more nitrates, one or more bacteria, one or more viruses, one or more fungi, one or more colors, one or more flavors, one or more scents, one or more minerals, sulfur, phosphorous, or any derivative of any of these components, or any combination thereof.

### Electrospinning Fibers

Electrospinning is a method which may be used to process a polymer solution into a fiber. In embodiments wherein the diameter of the resulting fiber is on the nanometer scale, the fiber may be referred to as a nanofiber. Fibers may be formed into a variety of shapes by using a range of receiving surfaces, such as mandrels or collectors. In some embodiments, a flat shape, such as a sheet or sheet-like fiber mold, a fiber scaffold and/or tube, or a tubular lattice, may be formed by using a substantially round or cylindrical mandrel. In certain embodiments, the electrospun fibers may be cut and/or unrolled from the mandrel as a fiber mold to form the sheet. The resulting fiber molds or shapes may be used in many applications, including filters and the like.

Electrospinning methods may involve spinning a fiber from a polymer solution by applying a high DC voltage potential between a polymer injection system and a mandrel. In some embodiments, one or more charges may be applied to one or more components of an electrospinning system. In some embodiments, a charge may be applied to the mandrel, the polymer injection system, or combinations or portions thereof. Without wishing to be bound by theory, as the polymer solution is ejected from the polymer injection system, it is thought to be destabilized due to its exposure to a charge. The destabilized solution may then be attracted to a charged mandrel. As the destabilized solution moves from the polymer injection system to the mandrel, its solvents may evaporate and the polymer may stretch, leaving a long, thin fiber that is deposited onto the mandrel. The polymer solution may form a Taylor cone as it is ejected from the polymer injection system and exposed to a charge.

In certain embodiments, a first polymer solution comprising a first polymer and a second polymer solution comprising a second polymer may each be used in a separate polymer injection system at substantially the same time to produce one or more electrospun fibers comprising the first polymer interspersed with one or more electrospun fibers comprising the second polymer. Such a process may be referred to as “co-spinning” or “co-electrospinning,” and a scaffold produced by such a process may be described as a co-spun or co-electrospun scaffold.

### Polymer Injection System

A polymer injection system may include any system configured to eject some amount of a polymer solution into an atmosphere to permit the flow of the polymer solution from the injection system to the mandrel. In some embodiments, the polymer injection system may deliver a continuous or linear stream with a controlled volumetric flow rate of a polymer solution to be formed into a fiber. In some embodiments, the polymer injection system may deliver a variable stream of a polymer solution to be formed into a fiber. In some embodiments, the polymer injection system may be configured to deliver intermittent streams of a polymer solution to be formed into multiple fibers. In some embodiments, the polymer injection system may include a syringe under manual or automated control. In some embodiments, the polymer injection system may include multiple syringes and multiple needles or needle-like components under individual or combined manual or automated control. In some embodiments, a multi-syringe polymer injection system may include multiple syringes and multiple needles or needle-like components, with each syringe containing the same polymer solution. In some embodiments, a multi-syringe polymer injection system may include multiple syringes and multiple needles or needle-like components, with each syringe containing a different polymer solution. In some embodiments, a charge may be applied to the polymer injection system, or to a portion thereof. In some embodiments, a charge may be applied to a needle or needle-like component of the polymer injection system.

In some embodiments, the polymer solution may be ejected from the polymer injection system at a flow rate of less than or equal to about 5 mL/h per needle. In other embodiments, the polymer solution may be ejected from the polymer injection system at a flow rate per needle in a range from about 0.01 mL/h to about 50 mL/h. The flow rate at which the polymer solution is ejected from the polymer injection system per needle may be, in some non-limiting examples, about 0.01 mL/h, about 0.05 mL/h, about 0.1 mL/h, about 0.5 mL/h, about 1 mL/h, about 2 mL/h, about 3 mL/h, about 4 mL/h, about 5 mL/h, about 6 mL/h, about 7 mL/h, about 8 mL/h, about 9 mL/h, about 10 mL/h, about 11 mL/h, about 12 mL/h, about 13 mL/h, about 14 mL/h, about 15 mL/h, about 16 mL/h, about 17 mL/h, about 18 mL/h, about 19 mL/h, about 20 mL/h, about 21 mL/h, about 22 mL/h, about 23 mL/h, about 24 mL/h, about 25 mL/h, about 26 mL/h, about 27 mL/h, about 28 mL/h, about 29 mL/h, about 30 mL/h, about 31 mL/h, about 32 mL/h, about 33 mL/h, about 34 mL/h, about 35 mL/h, about 36 mL/h, about 37 mL/h, about 38 mL/h, about 39 mL/h, about 40 mL/h, about 41 mL/h, about 42 mL/h, about 43 mL/h, about 44 mL/h, about 45 mL/h, about 46 mL/h, about 47 mL/h, about 48 mL/h, about 49 mL/h, about 50 mL/h, or any range between any two of these values, including endpoints.

As the polymer solution travels from the polymer injection system toward the mandrel, the diameter of the resulting fibers may be in the range of about 100 nm to about 1500 nm. Some non-limiting examples of electrospun fiber diameters may include about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1,000 nm, about 1,050 nm, about 1,100 nm, about 1,150 nm, about 1,200 nm, about 1,250 nm, about 1,300 nm, about 1,350 nm, about 1,400 nm, about 1,450 nm, about 1,500 nm, or any range between any two of these values, including endpoints. In some embodiments, the electrospun fiber diameter may be from about 300 nm to about 1300 nm.

### Polymer Solution

In some embodiments, the polymer injection system may be filled with a polymer solution. In some embodiments, the polymer solution may comprise one or more polymers. In some embodiments, the polymer solution may be a fluid formed into a polymer liquid by the application of heat. A polymer solution may include, for example, non-resorbable polymers, resorbable polymers, natural polymers, or a combination thereof.

In some embodiments, the polymers may include, for example, nylon, nylon 6,6, polycaprolactone, polyethylene oxide terephthalate, polybutylene terephthalate, polyethylene oxide terephthalate-co-polybutylene terephthalate, polyethylene terephthalate, polyurethane, polyethylene, polyethylene oxide, polyester, polymethylmethacrylate, polyacrylonitrile, silicone, polycarbonate, polyether ketone ketone, polyether ether ketone, polyether imide, polyamide, polystyrene, polyether sulfone, polysulfone, polyvinyl acetate, polytetrafluoroethylene, polyvinylidene fluoride, polylactic acid, polyglycolic acid, polylactide-co-glycolide, polylactide-co-caprolactone, polyglycerol sebacate, polydioxanone, polyhydroxybutyrate, poly-4-hydroxybutyrate, trimethylene carbonate, polydiols, polyesters, collagen, gelatin, fibrin, fibronectin, albumin, hyaluronic acid, elastin, chitosan, alginate, silk, copolymers thereof, and combinations thereof.

It may be understood that polymer solutions may also include a combination of one or more of non-resorbable, resorbable polymers, and naturally occurring polymers in any combination or compositional ratio. In an alternative embodiment, the polymer solutions may include a combination of two or more non-resorbable polymers, two or more resorbable polymers or two or more naturally occurring polymers. In some non-limiting examples, the polymer solution may comprise a weight percent ratio of, for example, from about 5% to about 90%. Non-limiting examples of such weight percent ratios may include about 5%, about 10%, about 15%, about 20%, about 25%, about 30%, about 33%, about 35%, about 40%, about 45%, about 50%, about 55%, about 60%, about 66%, about 70%, about 75%, about 80%, about 85%, about 90%, or ranges between any two of these values, including endpoints.

In some embodiments, the polymer solution may comprise one or more solvents. In some embodiments, the solvent may comprise, for example, hexafluoro-2-propanol (HFIP), acetone, dimethylformamide, dimethylsulfoxide, N-methylpyrrolidone, N,N-dimethylformamide, Nacetonitrile, hexanes, ether, dioxane, ethyl acetate, pyridine, toluene, xylene, tetrahydrofuran, trifluoroacetic acid, hexafluoroisopropanol, acetic acid, dimethylacetamide, chloroform, dichloromethane, water, alcohols, ionic compounds, or combinations thereof. The concentration range of polymer or polymers in solvent or solvents may be, without limitation, from about 1 wt % to about 50 wt %. Some non-limiting examples of polymer concentration in solution may include about 1 wt %, 3 wt %, 5 wt %, about 10 wt %, about 15 wt %, about 20 wt %, about 25 wt %, about 30 wt %, about 35 wt %, about 40 wt %, about 45 wt %, about 50 wt %, or ranges between any two of these values, including endpoints.

In some embodiments, the polymer solution may also include additional materials. Non-limiting examples of such additional materials may include radiation opaque materials, contrast agents, electrically conductive materials, fluorescent materials, luminescent materials, antibiotics, growth factors, vitamins, cytokines, steroids, anti-inflammatory drugs, small molecules, sugars, salts, peptides, proteins, cell factors, DNA, RNA, other materials to aid in non-invasive imaging, or any combination thereof. In some embodiments, the radiation opaque materials may include, for example, barium, tantalum, tungsten, iodine, gadolinium, gold, platinum, bismuth, or bismuth (III) oxide. In some embodiments, the electrically conductive materials may include, for example, gold, silver, iron, or polyaniline.

In certain embodiments, the polymer solution may comprise an additive that is configured to react with chlorine or another undesirable component. That is, the additive drives, or is configured to or capable of driving, a chemical reaction to remove chlorine (or other undesirable component) from a liquid, or changes the form of the chlorine (or other undesirable component) in the liquid, or both. In other words, the additive is configured to neutralize chlorine (or another undesirable component) in the liquid, and/or to remove chlorine (or another undesirable component) from a liquid when the liquid contacts the additive. Said differently, the additive is reactive to chlorine (or another undesirable component) in a way that removes, neutralizes, or changes the form of the chlorine (or other undesirable component). In this context, the phrase “configured to” indicates the additive's activity when exposed to chlorine (or another undesirable component), such that when the additive contacts chlorine (or another undesirable component), it will do what it is “configured to” do—drive a chemical reaction to remove, change, or neutralize the chlorine (or other undesirable component). The additive may be, for example, activated carbon, activated carbon nanoparticles, ascorbic acid, one or more cationic materials, one or more antioxidants, or combinations thereof.

In some embodiments, the additional materials and/or additives may be present in the polymer solution in an amount from about 1 wt % to about 1500 wt % of the polymer mass. In some non-limiting examples, the additional materials may be present in the polymer solution in an amount of about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 100 wt %, about 125 wt %, about 150 wt %, about 175 wt %, about 200 wt %, about 225 wt %, about 250 wt %, about 275 wt %, about 300 wt %, about 325 wt %, about 350 wt %, about 375 wt %, about 400 wt %, about 425 wt %, about 450 wt %, about 475 wt %, about 500 wt %, about 525 wt %, about 550 wt %, about 575 wt %, about 600 wt %, about 625 wt %, about 650 wt %, about 675 wt %, about 700 wt %, about 725 wt %, about 750 wt %, about 775 wt %, about 800 wt %, about 825 wt %, about 850 wt %, about 875 wt %, about 900 wt %, about 925 wt %, about 950 wt %, about 975 wt %, about 1000 wt %, about 1025 wt %, about 1050 wt %, about 1075 wt %, about 1100 wt %, about 1125 wt %, about 1150 wt %, about 1175 wt %, about 1200 wt %, about 1225 wt %, about 1250 wt %, about 1275 wt %, about 1300 wt %, about 1325 wt %, about 1350 wt %, about 1375 wt %, about 1400 wt %, about 1425 wt %, about 1450 wt %, about 1475 wt %, about 1500 wt %, or any range between any of these two values, including endpoints. In one embodiment, the polymer solution may include an effective amount of an additive configured to react with chlorine, as described herein, wherein the effective amount of the additive is from about 40 wt % to about 400 wt % based on the weight of the polymer.

The type of polymer in the polymer solution may determine the characteristics of the electrospun fiber. Some fibers may be composed of polymers that are bio-stable and not absorbable or biodegradable when implanted. Such fibers may remain generally chemically unchanged for the length of time in which they remain implanted. Alternatively, fibers may be composed of polymers that may be absorbed or bio-degraded over time. It may be further understood that a polymer solution and its resulting electrospun fiber(s) may be composed or more than one type of polymer, and that each polymer therein may have a specific characteristic, such as bio-stability, biodegradability, or bioabsorbability.

### Applying Charges to Electrospinning Components

In an electrospinning system, one or more charges may be applied to one or more components, or portions of components, such as, for example, a mandrel or a polymer injection system, or portions thereof. In some embodiments, a positive charge may be applied to the polymer injection system, or portions thereof. In some embodiments, a negative charge may be applied to the polymer injection system, or portions thereof. In some embodiments, the polymer injection system, or portions thereof, may be grounded. In some embodiments, a positive charge may be applied to mandrel, or portions thereof. In some embodiments, a negative charge may be applied to the mandrel, or portions thereof. In some embodiments, the mandrel, or portions thereof, may be grounded. In some embodiments, one or more components or portions thereof may receive the same charge. In some embodiments, one or more components, or portions thereof, may receive one or more different charges.

The charge applied to any component of the electrospinning system, or portions thereof, may be from about −15 kV to about 30 kV, including endpoints. In some non-limiting examples, the charge applied to any component of the electrospinning system, or portions thereof, may be about −15 kV, about −10 kV, about −5 kV, about −4 kV, about −3 kV, about −1 kV, about −0.01 kV, about 0.01 kV, about 1 kV, about 5 kV, about 10 kV, about 11 kV, about 11.1 kV, about 12 kV, about 15 kV, about 20 kV, about 25 kV, about 30 kV, or any range between any two of these values, including endpoints. In some embodiments, any component of the electrospinning system, or portions thereof, may be grounded.

### Mandrel Movement During Electrospinning

During electrospinning, in some embodiments, the mandrel may move with respect to the polymer injection system. In some embodiments, the polymer injection system may move with respect to the mandrel. The movement of one electrospinning component with respect to another electrospinning component may be, for example, substantially rotational, substantially translational, or any combination thereof. In some embodiments, one or more components of the electrospinning system may move under manual control. In some embodiments, one or more components of the electrospinning system may move under automated control. In some embodiments, the mandrel may be in contact with or mounted upon a support structure that may be moved using one or more motors or motion control systems. The pattern of the electrospun fiber deposited on the mandrel may depend upon the one or more motions of the mandrel with respect to the polymer injection system. In some embodiments, the mandrel surface may be configured to rotate about its long axis. In one non-limiting example, a mandrel having a rotation rate about its long axis that is faster than a translation rate along a linear axis, may result in a nearly helical deposition of an electrospun fiber, forming windings about the mandrel. In another example, a mandrel having a translation rate along a linear axis that is faster than a rotation rate about a rotational axis, may result in a roughly linear deposition of an electrospun fiber along a liner extent of the mandrel.

### Devices and Methods for Water Filtration

The instant disclosure is directed to devices and methods for water filtration. It may be understood that the devices and methods described herein may be applied to the filtration of any liquid substance, and that the examples described herein are non-limiting.

To remove chlorine from drinking liquids such as water, the Applicant has designed several different filters. These filters were created by formulating a solution comprising: (i) a polymer to form fibers; (ii) a solvent to enable a homogeneous mixture that can be electrospun; and (iii) an additive that drives, or is configured to or capable of driving, a chemical reaction to remove chlorine from a liquid, changes the form of the chlorine in the liquid, or both. In other words, the additive is one configured to neutralize chlorine in the liquid, and/or to remove the chlorine from the liquid. The solution was then electrospun as described herein. The electrospun fibers have a diameter of about 300 nm to about 1300 nm, as described herein, which is optimal because it allows the liquid to contact a high surface area of the fibers as the liquid travels through the filter.

In some embodiments described further herein, the additive that drives a chemical reaction to remove chlorine from a liquid is activated carbon, which may be in the form of activated carbon nanoparticles, or in another form. Activated carbon is thought to be effective in removing chlorine from liquids because the activated carbon is formed with carbon radicals, which are extremely reactive. For example, the below reaction shows the hydrolysis of free chlorine in water, which results in the formation of hypochlorous acid and hydrochloric acid, respectively. These chemicals will interact with a filter as described herein.

Cl₂+H₂O→HOCl+HCl

The reaction below shows how a radical active site in the carbon dissociates the hypochlorous acid.

Activated Carbon+HOCl→C.O+H⁺+Cl⁻

The reaction below shows how a radical active site in the carbon dissociates the hydrochloric acid.

Activated Carbon+HCl⁻→C.H+Cl⁻

In other embodiments described further herein, the additive that drives a chemical reaction to remove chlorine from a liquid is ascorbic acid. Ascorbic acid is thought to be effective in removing chlorine because it is stable enough to restructure its own bonds to free hydrogen, resulting in isolated chloride. For example, the below reaction shows how ascorbic acid isolates chloride from hypochlorous acid.

C₅H₅O₅CH₂OH+HOCl→C₅H₃O₅CH₂OH+H⁺+Cl⁻+H₂O

In some embodiments, a filter may comprise electrospun polymer fibers, as described herein, the fibers comprising an effective amount of an additive. The additive may be configured to react with chlorine, as described herein. In certain embodiments, the additive may be activated carbon, activated carbon nanoparticles, ascorbic acid, or combinations thereof. In some embodiments, the electrospun polymer fibers may comprise a polymer as described herein. In certain embodiments, the polymer may be nylon 6,6, polycaprolactone, co-polymers thereof, or combinations thereof.

The “effective amount” of the additive may be an amount capable of reacting with a substantial portion of the chlorine in a liquid, thereby removing the substantial amount of chlorine from the liquid. In one non-limiting example, the effective amount of the additive may be an amount capable of reacting with about 85% of the chlorine in the liquid, thereby removing about 85% of the chlorine from the liquid when the liquid is passed through the filter. In some embodiments, the effective amount of the additive may be from about 40 wt % to about 400 wt % based on the weight of the electrospun polymer fibers, as described herein. In one embodiment, the effective amount of the additive may be about 40 wt % based on the weight of the electrospun polymer fibers.

In some embodiments, the electrospun polymer fibers may have a diameter from about 300 nm to about 1300 nm, as described herein. Without wishing to be bound by theory, this range of diameters may be optimal because it may allow a liquid to contact a high surface area of the fibers as the liquid travels through the filter.

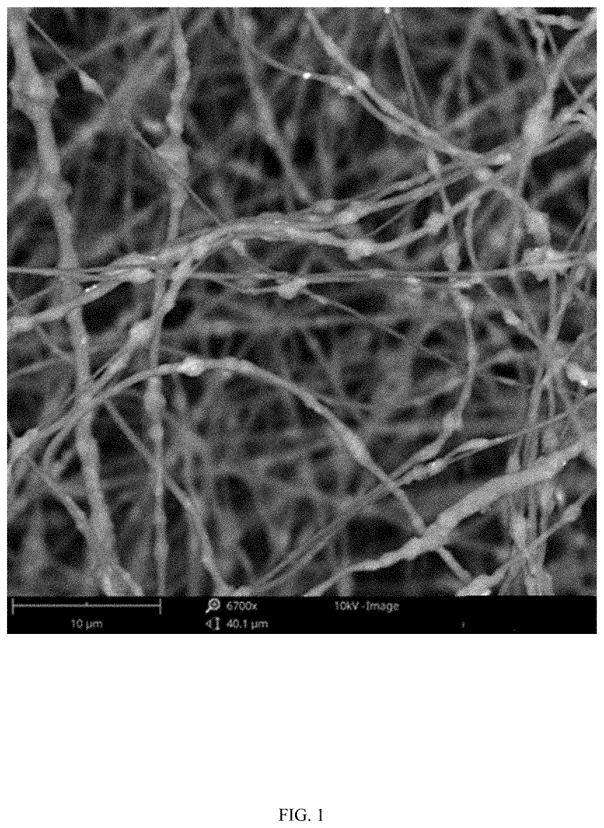

In an embodiment, the electrospun polymer fibers of a filter may comprise nylon 6,6, and the additive may comprise activated carbon nanoparticles. FIG. 1, for example, is a scanning electron microscope (SEM) image of an embodiment of a filter comprising electrospun polymer fibers comprising an effective amount of an additive, wherein the electrospun polymers comprise nylon 6,6, and wherein the additive is activated carbon nanoparticles.

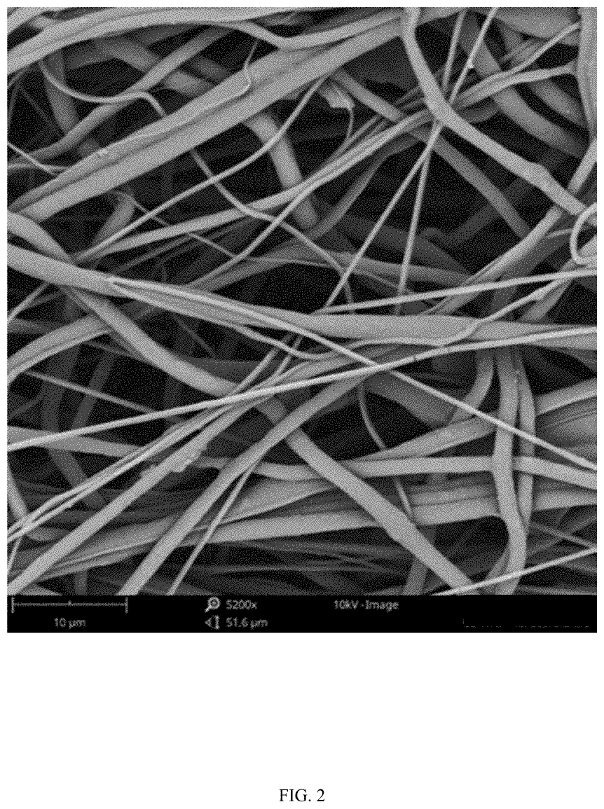

In another embodiment, the electrospun polymer fibers of a filter may comprise polycaprolactone, and the additive may comprise ascorbic acid. FIG. 2, for example, is an SEM image of an embodiment of a filter comprising electrospun polymer fibers comprising an effective amount of an additive, wherein the electrospun polymers comprise polycaprolactone, and wherein the additive is ascorbic acid.

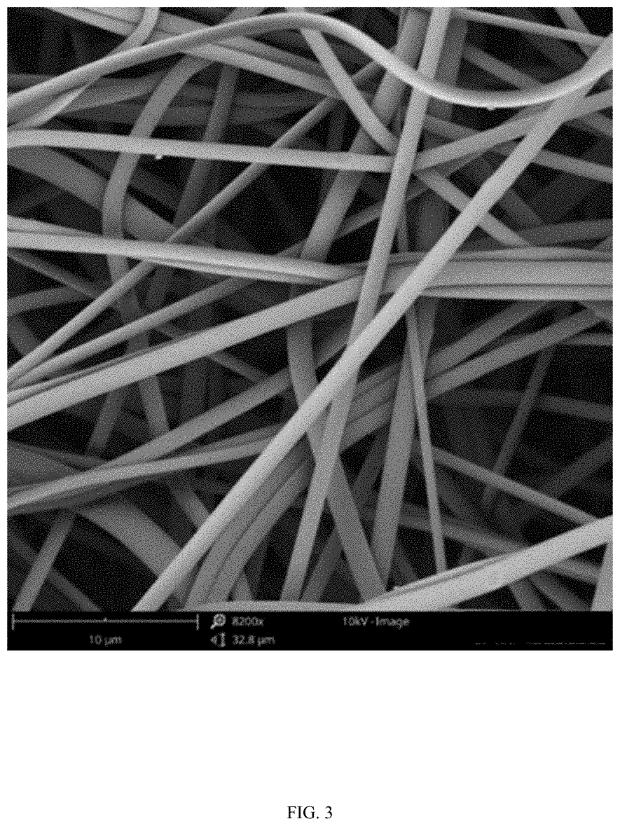

In yet another embodiment, the electrospun polymer fibers of a filter may comprise nylon 6,6, and the additive may comprise ascorbic acid. FIG. 3, for example, is an SEM image of an embodiment of a filter comprising electrospun polymer fibers comprising an effective amount of an additive, wherein the electrospun polymers comprise nylon 6,6, and wherein the additive is ascorbic acid.

In some embodiments, the filter described herein may be configured to be placed in a container capable of holding a liquid. In one embodiment, for example, the container may be a water bottle, and the filter may be located within the water bottle such that the liquid may pass through the filter as it is being poured into the water bottle. In some embodiments, the container may hold from about 4 oz. of a liquid to about 256 oz. of a liquid. The container may hold, for example, about 4 oz., about 8oz., about 12 oz., about 16 oz., about 24 oz., about 32 oz., about 40 oz., about 48 oz., about 56 oz., about 64 oz., about 72 oz., about 80 oz., about 88 oz., about 96 oz., about 104 oz., about 112 oz., about 120 oz., about 128 oz., about 136 oz., about 144 oz., about 152 oz., about 160 oz., about 168 oz., about 176 oz., about 184 oz., about 192 oz., about 200 oz., about 208 oz., about 216 oz., about 224 oz., about 232 oz., about 240 oz., about 248 oz., or about 256 oz. of a liquid, or any range between any two of these values, including endpoints. In other embodiments, the filter described herein may be placed intermediately between a water bottle and its mouthpiece, such that the liquid will have to pass from the bottle, through the filter and into the mouthpiece for consumption. In still other embodiments, the container may include a cylinder housing the filter described herein, such that the liquid will pass from the outside of the cylinder, through its wall into the center of the cylinder, and then from the center of the cylinder to the mouthpiece.

In some embodiments, a method of manufacturing a filter as described herein may comprise mixing a homogeneous solution comprising a polymer, a solvent, and an effective amount of an additive, as described herein. The additive may be configured to react with chlorine, as described herein. The method may further comprise electrospinning the mixture, by the electrospinning processes described herein, to form a scaffold comprising electrospun polymer fibers and the additive. The method may still further comprise removing the scaffold from the mandrel to form the filter.

In some embodiments, the solvent may comprise hexafluoro-2-propanol (HFIP), as described herein. In certain embodiments, the homogeneous solution may comprise about from about 5 wt % to about 10 wt % of the polymer, and about 40 wt % of the additive based on the weight of the polymer. The homogeneous solution may comprise, for example, about 5 wt % of the polymer, about 6 wt % of the polymer, about 7 wt % of the polymer, about 8 wt % of the polymer, about 9 wt % of the polymer, about 10 wt % of the polymer, or any range between any two of these values, including endpoints.

In one non-limiting example, within the homogeneous solution, the polymer may be nylon 6,6, and the additive may be activated carbon, wherein the homogeneous solution comprises about 7 wt % of the polymer and about 40 wt % of the additive based on the weight of the polymer. In another non-limiting example, within the homogeneous solution, the polymer may be polycaprolactone, and the additive may be ascorbic acid, wherein the homogeneous solution comprises about 5 wt % of the polymer and about 40 wt % of the additive based on the weight of the polymer. In still another non-limiting example, within the homogeneous solution, the polymer may be nylon 6,6, and the additive may be ascorbic acid, wherein the homogeneous solution comprises about 8 wt % of the polymer and about 40 wt % of the additive based on the weight of the polymer.

In some embodiments, the method of manufacturing may further comprise cutting the scaffold to fit into a container capable of holding a liquid. In one embodiment, for example, the container may be a water bottle, and the method may further include locating the filter within the water bottle such that the liquid may pass through the filter as it is being poured into the water bottle. In other embodiments, the container may be a water bottle, and the method may further include locating the filter intermediately between the water bottle and its mouthpiece, such that the liquid will have to pass from the bottle, through the filter and into the mouthpiece for consumption. In still other embodiments, the container may be a water bottle with a cylinder having a wall, and the method may further include locating the filter within the cylinder, such that the liquid will pass from the outside of the cylinder, through its wall into the center of the cylinder, and then from the center of the cylinder to the mouthpiece. In some embodiments, the filter may be located within a container capable of holding the purified liquid, such as a water bottle, as described herein.

In some embodiments, a method of filtering a chlorine-containing liquid may comprise exposing the chlorine-containing liquid to a filter as described herein, wherein exposing the chlorine-containing liquid to the filter produces a purified liquid, and collecting the purified liquid.

In certain embodiments, the “purified liquid” may contain less chlorine than the “chlorine-containing” liquid, but the “purified liquid” might not be completely devoid or even substantially devoid of chlorine. In one embodiment, for example, the purified liquid contains about 85% less chlorine than the chlorine-containing liquid, meaning that the method of filtering the chlorine-containing liquid removes about 85% of the chlorine from the chlorine-containing liquid. In embodiments, the purified liquid may be suitable for drinking. In some embodiments, the chlorine-containing liquid is water. In certain embodiments, the purified liquid is purified water.

In some embodiments, the step of exposing the chlorine-containing liquid to the filter may be done at a flow rate of at least about 550 mL/min. In certain embodiments, this approximate flow rate may be a comfortable drinking rate for humans. In some instances, a lower flow rate may facilitate liquid filtration, but may frustrate human consumers.

In some embodiments, the step of exposing the chlorine-containing liquid to the filter may be done at a pressure of at most about 4.6 psi. In one example, the pressure of at most about 4.6 psi was determined using a test with a flow rate of about 550 mL/min in which a filter as described herein removed about 85% of the chlorine in the liquid. In other embodiments, increasing the concentration of the additive in the filter and decreasing the thickness of the filter may lower the pressure at which the step of exposing the chlorine-containing liquid to the filter is done. In still other embodiments, decreasing the flow rate or increasing the size of the filter may lower the pressure at which the step of exposing the chlorine-containing liquid to the filter is done.

While the present disclosure has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

1.-38. (canceled)

39. A filter comprising:
electrospun polymer fibers comprising an effective amount of an additive;
wherein the additive is configured to react with chlorine.

40. The filter of claim 39, wherein the additive is selected from the group consisting of activated carbon and ascorbic acid, and wherein the electrospun polymer fibers comprise a polymer selected from the group consisting of nylon 6,6; polycaprolactone; and combinations thereof.

41. The filter of claim 39, wherein the effective amount of the additive is from about 40 wt % to about 400 wt % based on the weight of the electrospun polymer fibers.

42. The filter of claim 39, wherein the electrospun polymer fibers have a diameter of about 300 nm to about 1,300 nm.

43. The filter of claim 39, wherein the electrospun polymer fibers comprise nylon 6,6, and wherein the additive comprises activated carbon nanoparticles.

44. The filter of claim 39, wherein the filter is configured to be placed in a container capable of holding a liquid.

45. A method of manufacturing a filter, the method comprising:
mixing a homogeneous solution comprising a polymer, a solvent, and an effective amount of an additive, wherein the additive is configured to react with chlorine;
electrospinning the mixture onto a mandrel to form a scaffold comprising electrospun polymer fibers and the additive; and
removing the scaffold from the mandrel to form the filter.

46. The method of claim 45, wherein the additive is selected from the group consisting of activated carbon and ascorbic acid, and wherein the polymer is selected from the group consisting of nylon 6,6; polycaprolactone; and combinations thereof.

47. The method of claim 45, wherein the effective amount of the additive is from about 40 wt % to about 400 wt % based on the weight of the electrospun polymer fibers.

48. The method of claim 45, wherein the homogeneous solution comprises from about 5 wt % to about 10 wt % of the polymer, and about 40 wt % of the additive based on the weight of the polymer.

49. The method of claim 45, wherein the polymer is nylon 6,6; wherein the additive is activated carbon; and wherein the homogeneous solution comprises about 7 wt % of the polymer, and about 40 wt % of the additive based on the weight of the polymer.

50. The method of claim 45, wherein the electrospun polymer fibers have a diameter of about 300 nm to about 1,300 nm.

51. A method of filtering a chlorine-containing liquid, the method comprising:
exposing the chlorine-containing liquid to a filter, the filter comprising:
electrospun polymer fibers comprising an effective amount of an additive;
wherein the additive is configured to react to chlorine;
wherein exposing the chlorine-containing liquid to the filter produces a purified liquid suitable for drinking; and
collecting the purified liquid suitable for drinking.

52. The method of claim 51, wherein the purified liquid contains about 85% less chlorine than the chlorine-containing liquid.

53. The method of claim 51, wherein exposing the chlorine-containing liquid to the filter is done at a flow rate of at least about 550 mL/min.

54. The method of claim 51, wherein exposing the chlorine-containing liquid to the filter is done at a pressure of at most about 4.6 psi.

55. The method of claim 51, wherein the additive is selected from the group consisting of activated carbon and ascorbic acid, and wherein the electrospun polymer fibers comprise a polymer selected from the group consisting of nylon 6,6; polycaprolactone; and combinations thereof.

56. The method of claim 51, wherein the effective amount of the additive is about 40 wt % based on the weight of the electrospun polymer fibers.

57. The method of claim 51, wherein the electrospun polymer fibers have a diameter of about 300 nm to about 1,300 nm.

58. The method of claim 51, wherein the electrospun polymer fibers comprise nylon 6,6, and wherein the additive comprises activated carbon nanoparticles.
